(19) United States
(12) Patent Application Publication
(10) Pub. No.: US 2010/0073391 A1
(43) Pub. Date: Mar. 25, 2010

(54) INFORMATIONAL CONTENT PRESENTATION VIA BACKDROP IMAGES

(75) Inventors: Steven Horowitz, Oakland, CA (US); Tomi Blinnikka, San Pablo, CA (US); Joseph Magnani, San Francisco, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/237,739

(22) Filed: Sep. 25, 2008

(51) Int. Cl. G09G 5/00; G06Q 30/00

(52) U.S. Cl. 345/581; 345/660; 705/14.58

(57) ABSTRACT

The subject matter disclosed herein relates to presenting informational content via a backdrop image within at least a portion of a computer generated container area.

### BACKGROUND

1. Field

The subject matter disclosed herein relates to data processing, and more particularly to methods and apparatuses that may be implemented to present informational content via backdrop image through one or more computing platforms and/or other like devices.

2. Information

Various map and geographic information systems may be utilized to deliver map image data to clients. For example, various Web-based mapping services may operate to deliver map image data to clients via a Web browser. Generally, such map image data may span a variety of geographic areas and may be displayed in several discrete zoom levels. Such map image data may further include additional information, such as street names, addresses, and businesses for display with a map image.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a diagram illustrating a map within a computer generated container area in accordance with one or more exemplary embodiments.

FIG. 2 is a diagram illustrating the map of FIG. 1 at an updated pan position in accordance with one or more exemplary embodiments.

FIG. 3 is a diagram illustrating a tiled informational backdrop in accordance with one or more exemplary embodiments.

FIG. 4 is a diagram illustrating a presented a portion of informational backdrop during a tiling of updated portions of the map of FIG. 2 in accordance with one or more exemplary embodiments.

FIG. 5 is a flow diagram illustrating a process for presenting an informational backdrop in accordance with one or more exemplary embodiments.

FIG. 6 is a block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In a client-server environment, such as may be used in a web-browser application, map images may be rendered on a map server in response to a user request for a map image and transferred to the client for display. For example, in response to a user request for a map image, a map server may render appropriate image data for a given area centered at a given location at a given zoom level associated with such a request, and may communicate such rendered image data to the client. Alternatively, map data may be transferred by a map server to a client in response to a user request, and the client may render the corresponding map images. Additionally, a client may instead render map images derived from self-contained or local map data.

Map servers may store and/or otherwise establish image data associated with large map images for transfer to clients. In some examples, however, such image data may not be stored physically with the map server; rather, the map data may be accessed by the map server from a local or remote database. Loading map data, transmitting and receiving map or image data, and/or rendering image data on the server or the client, may be computationally burdensome on the server, the client, or both. Accordingly, map image systems may experience some delays and/or lag time. For example, zooming (or scaling) or panning (such as centering and/or shifting) of a map image, and/or in some other manner affecting certain mapped details, may require additional image data to be retrieved by the map server for display, and as such, may necessitate additional storage and computational demands on the map server to store and render the corresponding map. Accordingly, as a client or user of the client changes and/or otherwise requests certain features (e.g., pans to a new location), there may be a time lag in the display of such a map as the map server accesses, renders, and transfers the new map data corresponding to the new map (e.g., with a different location) to the client, and/or as the client responds to such new map data and presents such to the user.

In some systems, map images may be rendered by one or more tiles. Such tiles may be formed based at least in part on vector map data. Such vector map data may include mathematical descriptions that may determine coordinates, length, and direction in which lines are drawn to form such tiles.

As will be discussed in greater detail below, when updating map images during pan, zoom, and/or other like operations, a backdrop may be presented. Such a backdrop may refer to one or more images that may be temporarily presented within a given container area in the absence of a given content image. As used herein the term “container area” refers to a graphical viewing area that establishes a boundary within which a presented portion of a given content image may be displayed. Such updating may occur when portions of a content image (such as those based on bitmap, vector, raster and/or other like image related data) that are off screen are loaded after a pan, zoom, and/or other like operations operation.

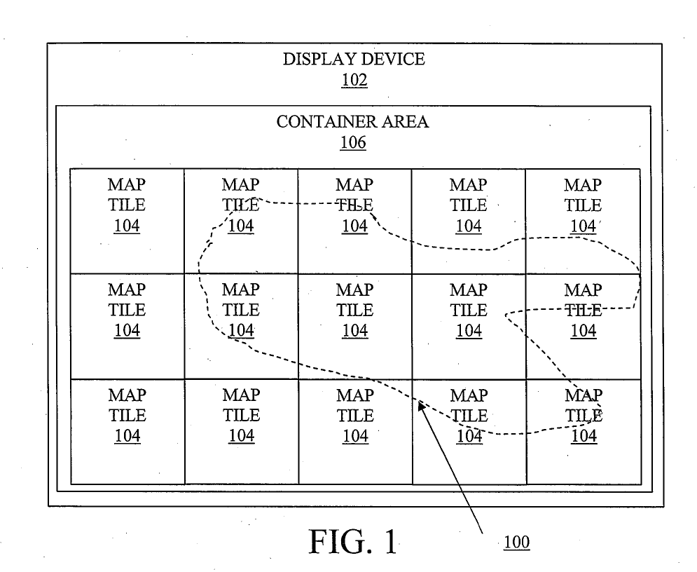

Referring to FIG. 1, a schematic diagram illustrates a map within a computer generated container area in accordance with one or more embodiments. As shown, a content image 100 may be presented on a display device 102. For example, such a display device 102 may include a computing platform, such as, e.g., a desktop computer, a workstation, a laptop computer, a tablet computer, a handheld computer, a Personal Digital Assistant, a mobile phone, a Smartphone, a portable media player, and/or the like, and/or combinations thereof. However, this is merely an example. Such a display device 102 may include may include one or more input/output (I/O) devices such as a display, keyboard, mouse, trackball; touchpad, joystick, touch screen, stylus, microphone, speaker, and/or the like, and/or combinations thereof.

Such a content image 100 may include one or more tiles 104. As used herein the term “tile” or “tiles” refers to as a discrete subsection of a larger image. Further, although shown as square in FIG. 1, tiles 104 may include any shape, e.g., rectangular, circular, elliptical and so on. Additionally or alternatively, individual tiles 104 may vary from one another in shape and size as well. Further, tiles 104 may include regions of overlap (e.g., adjacent tiles may overlap and cover the same area).

Such a content image 100 may comprise a map image, other images, and/or the like. Accordingly, while much of the description below is illustrated with a map-type image 100 and/or map tiles 104, it will be understood that such description may be equally applicable to other types of content images and/or content tiles.

In one example, a client device may have a static map application that may include associated vector data stored on such a client device. For example, such a static map application may be utilized by a client device that may perform the bulk of any data processing operations itself, and may not necessarily rely on a server, such as may be operational even in the absence of Internet access. In such a case, a static map application may generate one or more map tiles 104 from vector data for use in forming at least a portion of map image 100.

Alternatively, in a client-server environment as described above, such map tiles 104 may be separately processed by a map server and transferred to a client device for rendering. For example, data associated with map tiles 104 of map image 100 may be sent to a client device for rendering as a separate portion or sent as a set of vector data that may be rendered into map tiles 104 by a client device. Such map tiles 104 may vary in size for different applications and/or different processing capabilities of a client device.

A given map image 100 may include one or more map tiles 104 that may be stored in a database associated with a map server, may be determined at the time of a map request, and/or may be determined by a client device, for example. For example, such rendering from vector data may be done via a web-browser application, a static map application running on a client device, and/or the like. Such applications may include Scalable Vector Graphics (SVG), Canvas, Vector Markup Language (VML), Java Applet, Open Graphics Library (OpenGL), Flash, AJAX, and/or the like.

Accordingly, such a map image 100 may be presented within a container area 106 via one or more map tiles 104. Such a container area may establish a boundary within which a presented portion of map image 100 may be displayed. Hence, the term “container area” may also refer to a portion of memory and/or the data that may be stored in such a portion of memory, and which may be operatively associated with the presentation of certain graphical content images such as a presented portion of map image 100, tiles, etc. Such a container area 106 may be presented in a portion of display device 102. For example, in instances where display device 102 is a personal computer (or the like) such a container area 106 may be presented in a portion of display device 102. Alternatively, in instances where display device 102 is a mobile phone (or the like) such a container area 106 may be presented in an entire screen device 102.

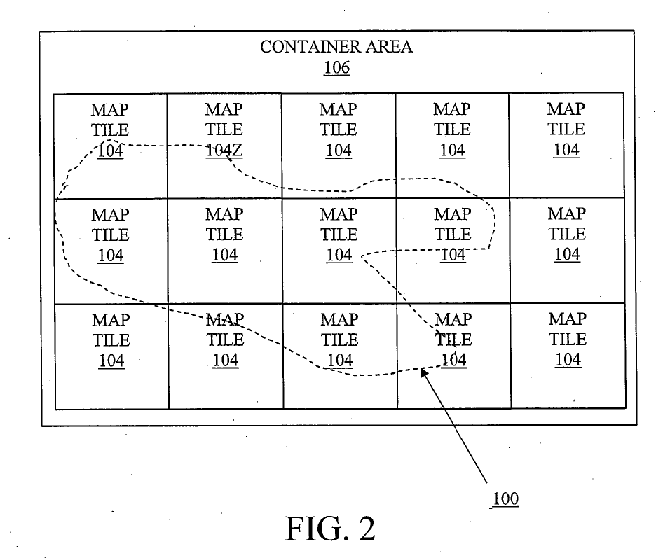

Referring to FIG. 2, a schematic diagram illustrates the map of FIG. 1 at an updated pan position in accordance with one or more embodiments. As illustrated, a user may alter a central point of map image 100 (referred to herein as “panning”). Similarly, a user may alter a zoom level of map image 100 (referred to herein as “zooming”). In such a case, updated portions of map image 100 may be tiled within container area 106. As used herein, the term “updated portions” may refer to updated and/or altered portions of image 100, and/or may refer to portions of image 100 that were not previously located within container area 106. In the case of zooming, an updated map image 100 may be formed out of all new map tiles 104, which may be sized and rendered based at least in part on the updated zoom level. For panning, at least a portion of an updated map image 100 (such as a portion that was previously off screen) may be formed out of new map tiles 104, which may be rendered based at least in part on the updated central point of map image 100. Similarly, a user may redraw via a request for a new map image 100 (referred to herein as “redrawing”). In the case of redrawing, an updated map image 100 may be formed out of all new map tiles 104, which may be sized and rendered based at least in part on a redraw request. For example, such a redraw request may be based on a request for a new location, a new search term, and/or the like. However, such tiling may not be instantaneous due to calculation and/or communication delays. Accordingly, in some cases, it may be possible that container area 106 may not be entirely filled with map tiles 104 during such a retiling.

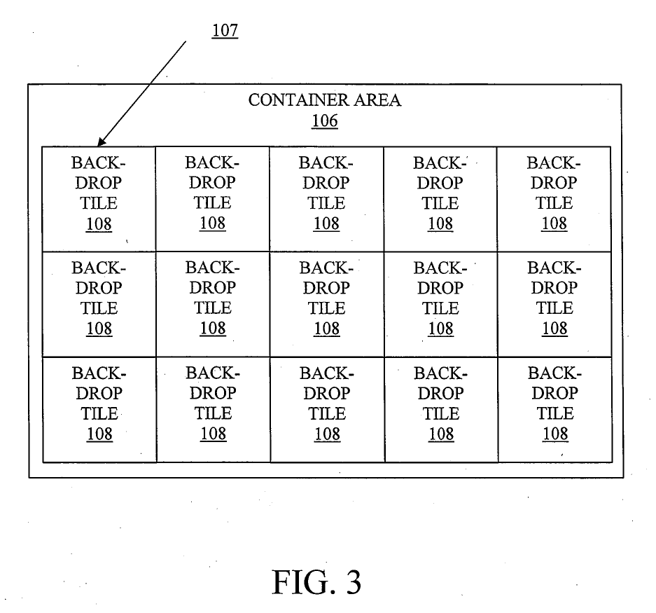

Referring to FIG. 3, a schematic diagram illustrates a tiled informational backdrop in accordance with one or more embodiments. As illustrated, a backdrop image 107 may be divided into a plurality of backdrop tiles 108. Further, although shown as square in FIG. 1, backdrop tiles 108 may include any shape, e.g., rectangular, circular, elliptical and so on. Additionally or alternatively, individual backdrop tiles 108 may vary from one another in shape and size as well. Further, backdrop tiles 108 may include regions of overlap (e.g., adjacent tiles may overlap and cover the same area). Such a feature may be for imaging features or attributes near or crossing a border of two adjacent tiles, for example.

In accordance with certain aspects of the present description, rather than leaving all or part of backdrop image 107 void of informational content (e.g., as might a solid colored region), all or part of backdrop section 107 may include informational content of some type that may be intended to be viewed (perhaps only momentarily) by the user. By way of example but not limitation, such a backdrop image 107 and/or individual backdrop tiles 108 may include advertising and/or other like informational content. For example, individual backdrop tiles 108 may form a series of informational components (e.g., advertising components, etc.) that may be distributed in some manner over all or part of container area 106. Such advertising information content may include promotional content, sponsorship content (such as logos and/or the like), and/or the like. Such backdrop tiles 108 may be tiled into container area 106 to form backdrop image 107. For example, one or more backdrop tiles 108 may be tiled in some repeating or other like manner container area 106 to form backdrop image 107.

In cases where a client device has a static map application, such informational content (such as advertising) may be present in an initial static map application. Additionally or alternatively, such informational content may be associated with one or more updates to such a static map application, such as an online update, and/or the like, for example. In such a case, a static map application may generate one or more informational backdrop tiles 108 based at least in part on such informational content for use in forming at least a portion of backdrop image 107.

In cases where a client device operates in a client-server environment, an ad server (not shown) may send such informational content to a client device for rendering. For example, an ad server may communicate to a client device directly and/or through a separate map server (not shown). For example, a client device may call to an ad server and poll from a number of available advertising content types of informational content. In a client-server environment, informational backdrop tiles 108 based at least in part on such advertising content may be separately processed by a map server or ad server and transferred to a client device for rendering. For example, informational backdrop tiles 108 may be sent to a client device for rendering as a separate portion or sent as a set of data representing advertising content that may be rendered into backdrop tiles 108 by a client device. In one example, a client may call an ad server once on loading a map application (or web-based application), and may use the same container backdrop while the map application is open.

Such advertising content may be selected based on one or more criteria. For example, such advertising content may be selected based at least in part on click-through data, a given location associated with map image 100, user demographics, other user information, and/or the like. For example, a client may call an ad server to download several backdrops and have these rotate according to some rule. In such a case, various logos (and/or other advertising content) may be downloaded and rotated according to such a rule. Such a rule may, for example, be based at least in part on one or more of the following conditions: count, time, map updating, zooming, panning, and/or the like, and/or combinations thereof. Alternatively, a client may call an ad server to download backdrops synchronously after individual adjustments of map image 100.

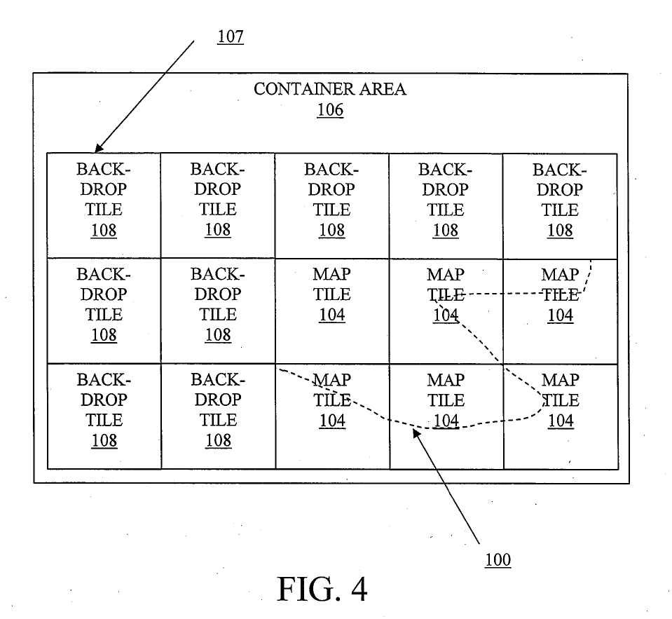

Referring to FIG. 4, a schematic diagram illustrates a presented portion of informational backdrop during a tiling of updated portions of the map of FIG. 2 in accordance with one or more embodiments. As illustrated, at least a portion of informational backdrop image 107 may be presented at certain times, such as in response to an adjustment of map image 100. For example, such an adjustment of map image 100 may include initial drawing of map image 100 and/or redrawing, panning, shifting, zooming, scaling, increasing details, decreasing details, combining another image (e.g. satellite or terrain), and/or other like operations affecting certain details of map image 100. In such a case, updated and/or refreshed portions map image 100 may be tiled within container area 106. During such a tiling of updated portions map image 100, at least a portion of informational backdrop image 107 may be presented and be capable of perception by a user. When such tiling of updated portions map image 100 is complete, some and/or all of informational backdrop image 107 may be covered and/or obscured by map image 100.

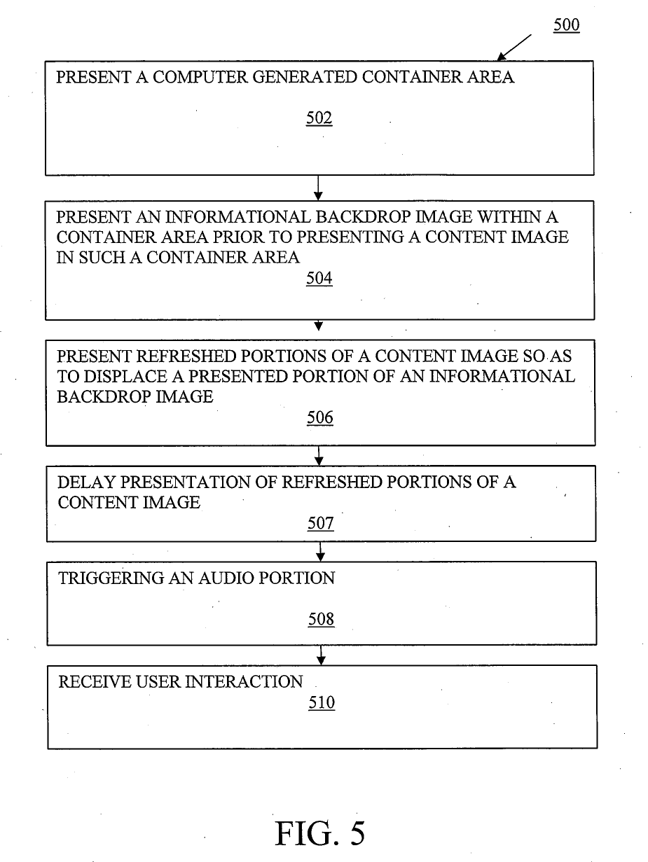

Referring to FIG. 5, a flow diagram illustrates a process for tiling an informational backdrop in accordance with one or more embodiments. Process 500, as illustrated in FIG. 5, may present at least a portion of an informational backdrop image within a container area in accordance with one or more embodiments, for example, although the scope of claimed subject matter is not limited in this respect. Additionally, although process 500, as shown in FIG. 5, comprises one particular order of blocks, the order in which the blocks are presented does not necessarily limit claimed subject matter to any particular order. Likewise, intervening blocks shown in FIG. 5 and/or additional blocks not shown in FIG. 5 may be employed and/or blocks shown in FIG. 5 may be eliminated, without departing from the scope of claimed subject matter.

Process 500, depicted in FIG. 5, may in certain embodiments be implemented in software, hardware, and/or firmware, and may comprise discrete operations. As illustrated, process 500 may present at least a portion of an informational backdrop image within a container area. Starting at block 502, a container area may be presented. Such a container area may be presented in a portion of a display device, for example.

At block 504, at least a portion of one informational backdrop image may be presented within at least a portion of such a container area prior to presenting at least a portion of a content image in such a portion of a container area. For instance, an informational backdrop image and/or a map image may be tiled within a container area. Such an informational backdrop image may include, at least in part, at least one advertising image. Additionally or alternatively, such an informational backdrop image may include a plurality of advertising components. For instance, such an informational backdrop image may include a series of repeated informational components (such as advertising components) distributed over such a container area. For example, individual backdrop tiles 108 (FIG. 3) may form a series of repeated informational components distributed over container area 106 (FIG. 3).

Such a presentation of an informational backdrop image may be in response to an adjustment of a content image. Such an informational backdrop image may be presented at certain times. For example, such an adjustment of content image may include an initiation of such a content image, redrawing, panning, shifting, zooming, scaling, increasing details, decreasing details, combining another image (e.g. satellite or terrain), and/or other like operations affecting certain details of content image.

Similarly, one or more map tiles 104 (FIG. 1) may be calculated from vector data and distributed within container area 106 (FIG. 1) for use in forming at least a portion of map image 100 (FIG. 1). Such a content image may include, at least in part, at least a portion of a map image.

At block 506, updated portions of a content image may be presented within a container area so as to displace such a presented portion of an informational backdrop image. Such displacement of a presented portion of an informational backdrop image may be in response to such an adjustment of such a content image. For example, such an adjustment of a map image may include redrawing, panning, and/or zooming of such a map image. Additionally, a visibility of such an informational backdrop image may be gradually altered (e.g. increased and/or decreased) in response to adjustment of such a map image. For example, during a presentation of informational backdrop image, such an informational backdrop image 107 (FIG. 4) may be faded-in from an initial blank or lower intensity presentation to a final fuller intensity presentation. Likewise, during a presentation of informational backdrop image 107 (FIG. 4), some or all of informational backdrop image 107 (FIG. 4) may be wiped-in from an initial blank or lower intensity presentation to a final fuller intensity presentation.

At block 507, such a presentation of updated portions of a content image may be delayed. For example, such a delay may be based, at least in part, on delaying a presentation of updated portions until a minimum exposure time to a given informational backdrop image has elapsed. Such a delay may improve the effectiveness of a given informational backdrop image, such as by being noticed and/or comprehended by a user viewing such an informational backdrop image. Alternatively, such a delay may be based, at least in part, on delaying such a presentation of updated portions at least until all updated portions of such a map image are ready to be presented within container area 106. Conversely, without such a delay, individual map tiles 104 (FIG. 4) may be sequentially displayed within container area 106 (FIG. 4) in the order that such individual map tiles 104 are sequentially calculated from vector data, transmitted, received, etc. In such a case, portions of a backdrop image 107 (FIG. 4) may be sequentially displaced by such sequentially displayed individual map tiles 104 (FIG. 4). At block 508, an audio portion associated with such an informational backdrop image may be triggered in response to such an adjustment of such a content image. For example such an audio portion may be associated with such an informational backdrop image and presented in some manner. Additionally or alternatively, at least a portion of an informational backdrop image may include an animated image, such as a sequence of images. Similarly, such an animated image may be triggered to play in response to an adjustment of a map image.

At block 510, at least a portion of such an informational backdrop image may be capable of receiving user interaction. Accordingly, user interaction associated, at least in part, with at least a portion of such an informational backdrop image may be received. For example, some or all of informational backdrop image 107 (FIG. 4) may be selectable in some manner (e.g., clickable, etc.) so as to be operable in some manner via user interaction. Such a user interaction with an informational backdrop image may cause a new informational backdrop image, animation and/or video to be displayed in the container area 106, trigger a link to a designated web page, trigger a pop-up type ad, halt and/or reverse tiling of updated portions of a map image, and/or the like.

In operation, when updating map images and/or other images during redraw, pan, and/or zoom operations, a backdrop may be tiled with an informational backdrop image, rather than using a blank or other backdrop. Such an informational backdrop image may present advertising content, such as corporate logos, Large Rectangle (LREC) type display ads, and/or the like via one or more backdrop tiles distributed within container area 106 to a user. Such tiling of an informational backdrop image may deliver brand impressions and/or the like that may register one or more times within a user's gaze. Additionally, such tiling of an informational backdrop image may be associated with paid for advertising and/or paid for sponsorship, so that an otherwise unused display space may be economically leveraged.

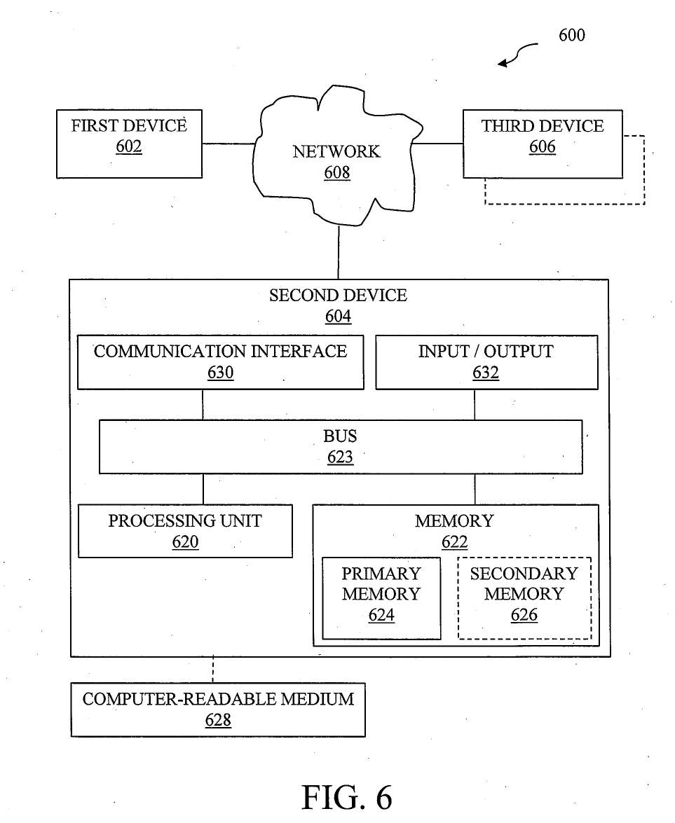

FIG. 6 is a block diagram illustrating an exemplary embodiment of a computing environment system 600 that may include one or more devices configurable to present at least a portion of an informational backdrop image in response to adjustment of a content image within a container area using one or more exemplary techniques illustrated above. For example, computing environment system 600 may be operatively enabled to perform all or a portion of process 500 of FIG. 5.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608. By way of example, but not limitation, any of first device 602, second device 604, or third device 606 may include: one or more computing platforms or devices, such as, e.g., a desktop computer, a laptop computer, a workstation, a server device, storage units, or the like.

Network 608, as shown in FIG. 6, is representative of one or more communication links, processes, and/or resources configurable to support the exchange of data between at least two of first device 602, second device 604 and third device 606. By way of example, but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 606, there may be additional like devices operatively coupled to network 608, for example.

It is recognized that all or part of the various devices and networks shown in system 600, and the processes and methods as further described herein, may be implemented using or otherwise include hardware, firmware, software, or any combination thereof.

Thus, by way of example, but not limitation, second device 604 may include at least one processing unit 620 that is operatively coupled to a memory 622 through a bus 623.

Processing unit 620 is representative of one or more circuits configurable to perform at least a portion of a data computing procedure or process. By way of example, but not limitation, processing unit 620 may include one or more processors, controllers, microprocessors, microcontrollers, application specific integrated circuits, digital signal processors, programmable logic devices, field programmable gate arrays, and the like, or any combination thereof. Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example, but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 632 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

In one implementation, an informational backdrop image and a map image may be tiled within a container area. Such tiling may be performed via a computing platform that manipulates or transforms electronic signals employed to represent physical electronic or magnetic quantities, or other physical quantities, within the computing platform's memories, registers, or other information storage, transmission, or display devices. For example, a computing platform may be enabled to tile a computer generated informational backdrop image and/or a computer generated map image within a computer generated container area. Likewise, a computing platform may be enabled to present at least a portion of such a computer generated informational backdrop image, in response to adjustment of such a computer generated map image. Further, a computing platform may be enabled to tile updated portions of such a computer generated map image within a computer generated container area so as to displace a presented portion of a computer generated informational backdrop image. Such a computer generated informational backdrop image, a computer generated map image, and/or a computer generated container area may be represented within such computing platforms by digital electronic signals employed to represent physical electronic or magnetic quantities, or other physical quantities.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method, comprising:
with a display device:
presenting a computer generated container area; and
presenting at least a portion of one advertising backdrop image within at least a portion of said computer generated container area prior to presenting at least a portion of a computer generated content image in said portion of a computer generated container area.

2. The method of claim 1, wherein said content image comprises, at least in part, at least a portion of a map image.

3. The method of claim 1, wherein said advertising backdrop image comprises, at least in part, at least one advertising component.

4. The method of claim 1, said computer generated container area being presented in a portion of said display device.

5. The method of claim 1, further comprising:
presenting updated portions of said computer generated content image within said computer generated container area so as to displace said presented portion of said advertising backdrop image in response to an adjustment of said computer generated content image.

6. The method of claim 1, further comprising:
presenting updated portions of said computer generated content image so as to displace said presented portion of said advertising backdrop image in response to an adjustment of said computer generated content image; and
delaying said presenting of updated portions of said computer generated content image.

7. The method of claim 1, wherein said presenting at least a portion of one advertising backdrop image within at least a portion of said computer generated container area is in response to an adjustment of said computer generated content image, wherein said adjustment of said computer generated content image comprises initiating a content image, redrawing, panning, shifting, zooming, scaling, increasing details, decreasing details, and/or combining another image.

8. The method of claim 1, further comprising:
gradually altering visibility of said advertising backdrop image in response to an adjustment of said computer generated content image, wherein said adjustment of said computer generated content image comprises redrawing, panning, shifting, zooming, scaling, increasing details, decreasing details, and/or combining another image.

9. The method of claim 1, further comprising:
receiving user interaction associated, at least in part, with at least a portion of said advertising backdrop image.

10. The method of claim 1, wherein at least a portion of said advertising backdrop image comprises an animated image.

11. The method of claim 1, further comprising:
triggering an audio portion associated with said advertising backdrop image in response to an adjustment of said computer generated content image.

12. The method of claim 1, wherein said advertising backdrop image comprises a plurality of advertising components.

13. The method of claim 1, further comprising:
presenting updated portions of said computer generated content image within said computer generated container area so as to displace said presented portion of said advertising backdrop image in response to an adjustment of said computer generated content image;
delaying said presenting of updated portions of said computer generated content image;
wherein said content image comprises, at least in part, at least a portion of a map image;
wherein said computer generated container area being presented in a portion of said display device;
wherein said presenting at least a portion of one advertising backdrop image within at least a portion of said computer generated container area is in response to said adjustment of said computer generated content image, wherein said adjustment of said computer generated content image comprises redrawing, panning, shifting, zooming, scaling, increasing details, decreasing details, and/or combining another image; and
wherein said advertising backdrop image comprises a plurality of advertising components.

14. An article comprising:
a storage medium comprising machine-readable instructions stored thereon, which, if executed by one or more processing units, operatively enable a computing platform to:
present a computer generated container area; and
present at least one advertising backdrop image within at least a portion of said computer generated container area prior to presenting at least a portion of a computer generated content image in said portion of a computer generated container area.

15. The article of claim 14, wherein said content image comprises, at least in part, at least a portion of a map image.

16. The article of claim 14, wherein said machine-readable instructions, if executed by the one or more processing units, operatively enable the computing platform to:
present updated portions of said computer generated content image so as to displace said presented portion of said advertising backdrop image in response to an adjustment of said computer generated content image; and
delay said presenting of updated portions of said computer generated content image.

17. The article of claim 14, wherein said advertising backdrop image comprises a plurality of advertising components.

18. An apparatus comprising:
a computing platform, said computing platform being operatively enabled to:
present a computer generated container area; and
present at least one advertising backdrop image within at least a portion of said computer generated container area prior to presenting at least a portion of a computer generated content image in said portion of a computer generated container area.

19. The apparatus of claim 18, wherein said content image comprises, at least in part, at least a portion of a map image, and wherein said advertising backdrop image comprises a plurality of advertising components.

20. The apparatus of claim 18, wherein said machine-readable instructions, if executed by a computing platform, further direct a computing platform to:
present updated portions of said computer generated content image so as to displace said presented portion of said advertising backdrop image in response to an adjustment of said computer generated content image; and
delay said presenting of updated portions of said computer generated content image.
